(19) United States
(12) Patent Application Publication
(10) Pub. No.: US 2020/0286311 A1
(43) Pub. Date: Sep. 10, 2020

(54) BRAKE AUDIBLE VERIFICATION APPARATUS, SYSTEM AND METHOD

(71) Applicant: Continental Automotive Systems, Inc., Auburn Hills, MI (US)

(72) Inventors: Ronald William SAGE, Milford, MI (US); Michael Anthony BAIBAK, Clarkston, MI (US); Frank William TICKNOR, Ortonville, MI (US); James Anthony POIRIER, Sterling Heights, MI (US)

(21) Appl. No.: 16/651,193

(22) PCT Filed: Sep. 27, 2018
(86) PCT No.: PCT/US2018/053171

§ 371 Date: Mar. 26, 2020

Related U.S. Application Data
(60) Provisional application No. 62/564,082, filed on Sep. 27, 2017.

(51) Int. Cl. G07C 5/08; B60T 17/22; B60T 8/17; H04W 4/40

(52) U.S. Cl. CPC G07C 5/0833; H04W 4/40; B60T 8/1708; B60T 17/22

(57) ABSTRACT

An apparatus, system and method for checking brake operation suitable to be executed by a single person is disclosed. A trigger is received from a trigger device. In response to the trigger, it is determined whether the vehicle is in motion. If the vehicle is determined to be substantially not in motion entering the test mode. In the test mode, sending a waveform to a brake actuator and causing the brake actuator to generate a sound audible to the person performing the test if a brake circuit is operational.

### BRIEF DESCRIPTION OF THE DRAWINGS

FIG. 1 is view of a trailer coupled to a towing vehicle and showing an example of usage of an exemplary system according to the disclosure including an exemplary trigger device;

FIG. 2 is a block diagram of an exemplary system according to the disclosure;

FIGS. 3-6 are diagrams of exemplary waveforms according to the disclosure; and

FIG. 7 is a flow chart depicting exemplary operation of audible brake verification according to the disclosure.

### DETAILED DESCRIPTION

Many trailers are equipped with braking systems. Three types of trailer brake actuation systems are commonly in use: pneumatic, hydraulic and electric. While the brake controlling technology often corresponds to the type of the actuation system in use, electrically controlled pneumatic and hydraulic systems also exist. Other combinations, of control and actuation technologies are also sometimes employed, for example hydraulic controlled air brakes and otherwise. Among the aforementioned technologies, those involving electricity are often prone to malfunctions due to, among others, electric connector/coupler failures, wire breaks, solenoid failures, corrosion and other causes of electrical disconnection or attenuation. Consequently, testing the operation of the electric elements of the brake system is important but nonetheless difficult to perform by a single person.

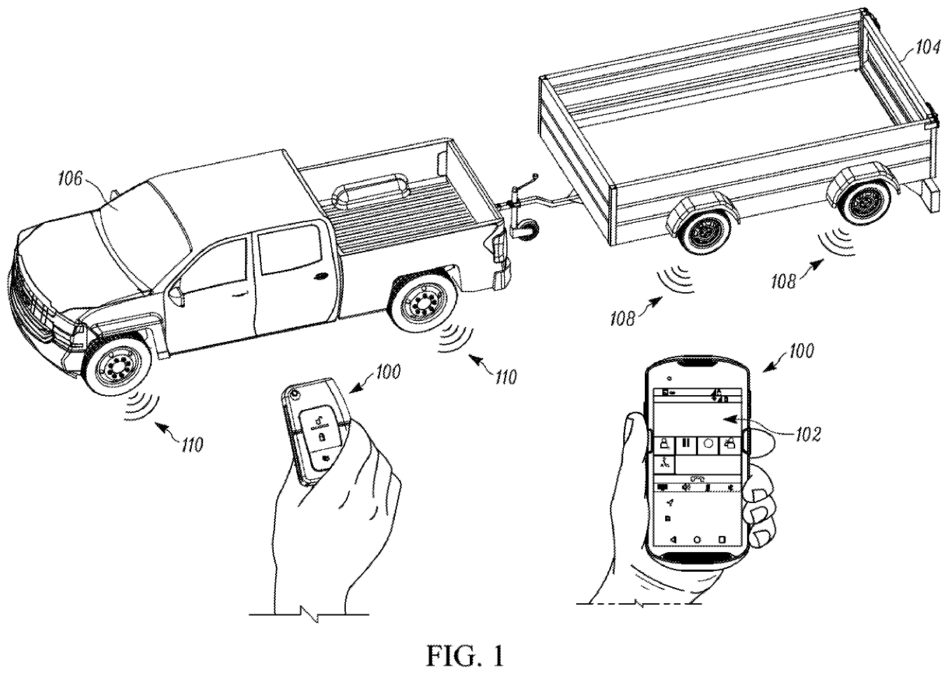

With reference to FIG. 1, for example, where the trailer 104 and therefore the trailer brake system is connected to a towing vehicle 106, e.g. the towing vehicle's brake or exterior light system, actuating the trailer's brakes typically requires actuating the towing vehicle's brake from the cab or the passenger compartment. Consequently, it is physically difficult, if not impossible, for a single person to both operate the towing vehicle's brakes and observe the operation of the trailer's brakes, typically at a substantial distance from the cab or passenger compartment, to confirm proper operation or discover a failure.

Even if the brakes are controlled from the trailer's on-board controller, simply actuating the brakes from the controller may not provide adequate indication of trailer brake operation as, for example, the person may be too far from the brakes to actuate the controller and observe the brakes operate at the same time. Similarly, the use of diagnostic devices, such as, for example, electrical resistance or impedance meters, may also fail to provide adequate indication of trailer brake operation while being cumbersome, at least somewhat complicated, potentially expensive and requiring additional equipment to be available. Accordingly, a new approach to testing electrically controlled or electrically actuated brakes is desirable.

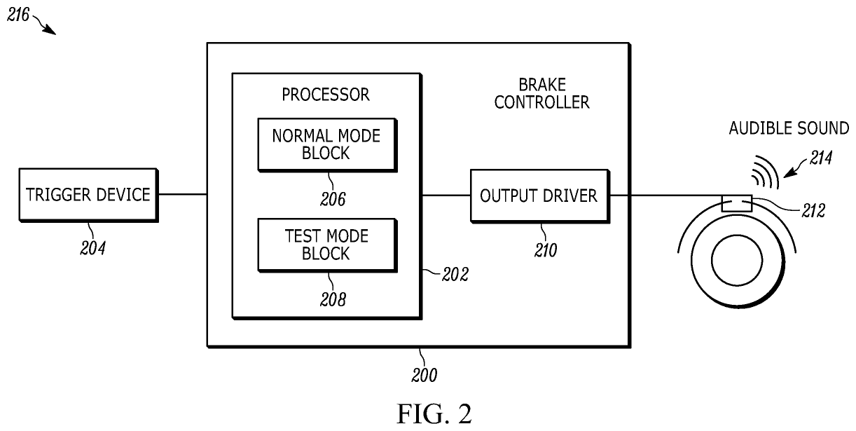

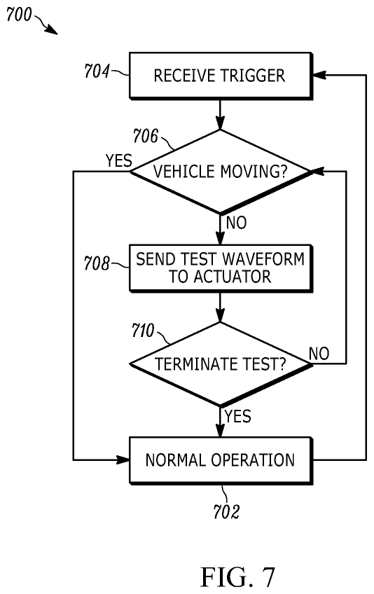

With reference to FIGS. 2 and 7, disclosed herein is an apparatus 200, system 216 and method 700 for checking brake operation suitable to be executed by a single person. While the disclosure describes exemplary embodiments on the basis of electrically controlled electrically actuated brakes, the principles disclosed herein can be applied to other types of brake control and actuation with analogous elements being substituted as needed or desired. In a non-limiting example of such systems some or all switches or gates may be substituted by valves, and electricity may be substituted by hydraulic or pneumatic fluid.

With reference to FIG. 2 and continued reference to FIG. 1, in an exemplary embodiment, a brake controller 200 receives a trigger to enter the brake test mode. The brake controller may be a brake controller comprised in the towing vehicle 106 or in the trailer 104. In addition to more conventional brake controllers, some examples of brake controllers comprise a Body Control Module (BCM), Trailer Lighting Module (TLM), a special Exterior Light Control Module (LCM). The trigger may be received from at least one of triggering devices 100, 204 communicatively coupled to the brake controller 200. In a nonlimiting example a triggering device may be an electrical switch, a toggle switch, a momentary switch or otherwise, a vehicle menu, a unique switch sequence, such as activation of headlamp or turn signal switch or using the trailer brake manual brake in a pre-determined sequence, a wireless device, a fob, a smart phone, a tablet, a personal computer, or another communication device, which is communicatively coupled to the brake controller via wired, wireless or fiberoptic technology. Aside from on/off status of a switch or a pulse or series of pulses (sometime referred to as hardwired signaling), some examples of communication technology that may be employed for communication of the trigger comprise Wi-Fi, Bluetooth, cellular, IR, RF, UHF, UWB, CAN, LIN, MOST, Ethernet, or otherwise. If a triggering device 100 is an intelligent device, the trigger may be generated through software 102, in a non-limiting example a fob firmware or software, a vehicle menu, or a smart phone or a tablet app. The triggering device may communicate with the controller directly, through a transmitter/receiver combination or through a network, in a nonlimiting example a Wi-Fi, Bluetooth, Ethernet or cellular network.

With reference to FIGS. 1, 2 and 7, upon receiving the trigger 704, the brake controller 200 may check whether the towing vehicle 106, if the trailer 104 is either mechanically or communicatively coupled to the towing vehicle 106, or the trailer 104 is in motion 706, in a non-limiting example whether the wheels are turning or whether the velocity is substantially non-zero. Some movement indication or non-zero velocity may be allowable to, for example, account for measurement error or jitter without the movement or velocity respectively being recognized as substantially non-zero.

If one or both of the towing vehicle and the trailer is moving, the controller may ignore the trigger and continue normal brake operation 702. In addition, the controller may generate a test error and optionally indicate it. The test error may be communicated to the triggering device 100 and indicated by the triggering device 100, e.g. with software 102. Similarly, the movement or velocity information may be communicated to the triggering device 100 and the triggering device 100 may both generate and indicate the error. Given the movement or velocity information the triggering device may also terminate the test mode 710.

So long as the movement or velocity information indicates that the respective towing vehicle or trailer is substantially not moving, the controller may begin or continue to operate in the test mode until the test mode is aborted or otherwise terminated, for example terminated on the basis of timer expiration. In a non-limiting example, the test mode may be actively terminated from the trigger device, e.g. by terminating the trigger or sending a termination trigger to the controller. Should the system detect movement or a demand for normal operation, e.g. a call to apply brakes, the system may switch 710 to normal operation 702.

In the test mode, the controller may send a waveform 708 to the actuator to cause the actuator to make a sound audible 108, 214, or optionally 110, to the person performing the test if the brake circuit comprising the brake controller 200, the actuator 212, and the communicative coupling therebetween is operational. In an aspect, the triggering device may indicate the parameters of the waveform to be sent to the actuator. In a nonlimiting example, the waveform parameters may be the frequency content of the waveform, the amplitude, the duty cycle, the period, and/or the duration. Alternatively, the triggering device may send an encoded waveform to the brake controller to be reproduced by the brake controller to the actuator. In an aspect the encoded waveform may serve as both, the trigger for test mode activation and the actual waveform to be reproduced to the actuator. Accordingly, in an aspect, terminating the provision of the encoded waveform may terminate the test mode.

In an aspect, an electrically actuated brake solenoid is the actuator that is made to oscillate at at least one frequency to generate an audible sound in response to the waveform. In another aspect an electrically controlled hydraulic pump is the actuator that generates an audible sound in response to the waveform.

The person performing the test may listen for the sound generated in response to the waveform and determine, based on the sound's presence or absence or other characteristics, whether the brake circuit and/or the actuator is operating in a desired fashion.

In a nonlimiting example the wave form comprises at least one frequency within the human audible range, e.g. 12 Hz-28 kHz or more generally 20 Hz-20 kHz. However, the choice of frequency or frequencies may depend on the hearing abilities of the persons targeted to perform the brake tests as well as the electrical and mechanical characteristics of the braking system. For example, humans are generally understood to be able to detect the direction of the sound source better at higher rather than lower frequencies. Accordingly, the test person would generally be able to better isolate a sound of a higher frequency from background noise and correspondingly associate the sound with an operating brake actuator. However, humans' sensitivity to frequencies above about 15 kHz diminishes drastically in relation to frequency. Moreover, humans' ability to hear sounds at about 12-14 kHz and above diminishes drastically with age. Young humans generally exhibit peak hearing sensitivity between about 500 Hz and 8 kHz, while older humans often peak only around 500 Hz. Furthermore, the electrical and mechanical characteristics of the braking system may also be considered. For example, the amount of energy to be dissipated at higher frequencies may only permit short transmissions with long pauses or a low duty cycle, e.g. less than about 10-20%. In addition, some systems may only deliver up to about 30 A of current at a full load continuous operation under optimal conditions. Also, the electrical and mechanical components and the brake system itself may have load limitations and resonant frequencies that may be desirable to either exploit or avoid. Some preferred frequencies that may be included in the waveform comprise about 250 Hz, about 600 Hz, and about 1 kHz. Frequency sweeps including at least some the aforementioned frequencies may also be desirable to cover variability between brake systems. One such nonlimiting exemplary frequency range may be between about 300 Hz and about 1.5 kHz. Others could start at about 250 or 600 Hz and end at about 600 or 1 kHz.

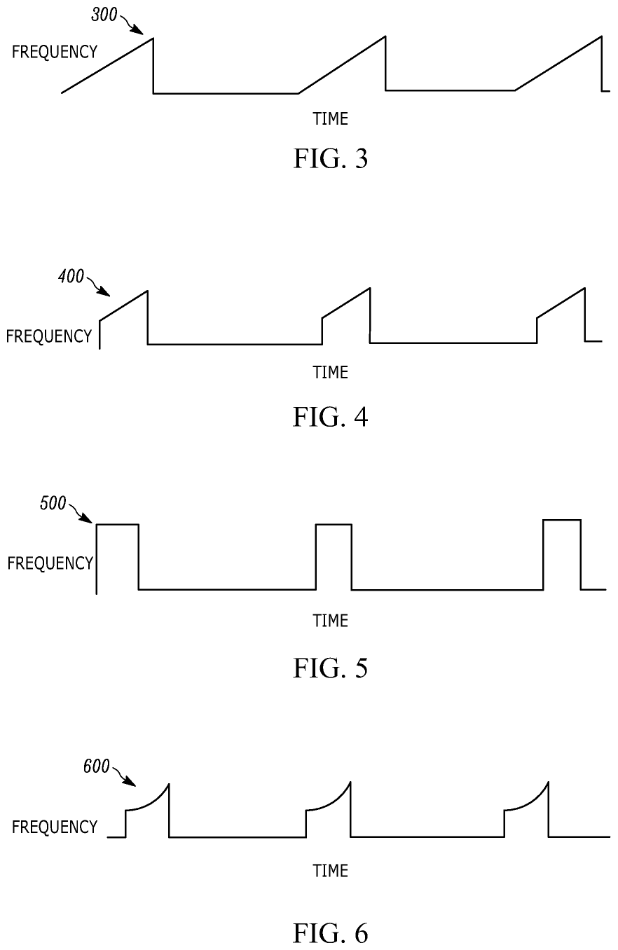

With reference to FIGS. 3-6, in an embodiment, the waveform may be a frequency ramp over time from a lower frequency limit to an upper frequency limit 300, 400, 600 or vice versus, a single frequency 500 or a plurality of frequencies, either in series or in parallel or both, respectively for a duration of a pulse width followed by an off period governed by the duty cycle. In an embodiment, the period of the cycle may be about 500 msec. In addition, in an aspect, the amplitude envelope of the waveform may be modulated.

It will be appreciated that the list of possible waveforms presented herein is not exclusive and therefore other waveforms may be desirable depending on the application. Moreover, in an aspect, the waveform may be customizable, either by the test person or otherwise to meet the preferences or the requirements of a particular application. To this end, in one nonlimiting example the triggering device or the brake controller may be programmed or reprogrammed to store the desired waveform or waveform parameters for subsequent use. Alternatively, the waveform or the waveform parameters may be adjusted in real-time or near real-time. In nonlimiting examples, the lower and upper frequency limits may be selected, or a single frequency or multiple frequencies may be selected. Similarly, in some embodiments an amplitude or amplitude envelope, duty cycle, cycle time and duration may be selected or otherwise modified.

With reference to FIG. 2, in an embodiment, the brake system comprises the triggering device 204 communicatively coupled to a brake controller apparatus. The brake controller 200 comprises a processor 202 and an output driver 210, wherein the output driver is communicatively coupled to a brake actuator 212. In an aspect, the processor is communicatively coupled to a computer-readable non-transitory medium having computer-executable instructions, the computer program instructions configured to, when executed by the processor, cause the processor to perform operations comprising receiving a trigger from the trigger device 204, in response to the trigger, determining whether the vehicle, for example a trailer or a towing vehicle, is in motion, entering the test mode 208 if the vehicle is determined to be substantially not in motion and remaining or switching to a normal mode 206 if the vehicle is determined to not be substantially not in motion. Wherein, the test mode comprises the step of sending a waveform to a brake actuator causing the actuator to generate a sound audible 214 to the person performing the test if the brake circuit comprising the brake controller, the actuator, and the communicative coupling therebetween is operational. In a refinement, the computer program instructions are configured to, when executed by the processor, cause the processor to perform operations further comprising detecting at least one of a movement and a demand for normal operation and switching to the normal mode in response to system detecting at least one of the movement and the demand for normal operation.

In an aspect the processor may comprise a microprocessor, a microcontroller, an FPGA, or an ASIC. In an aspect the output driver may comprise a transistor, a FET, a MOSFET, or an ASIC. In a nonlimiting example, the non-transitory medium may comprise read only memory, read/write memory, or a combination of read only and read/write memory. The processor and the output driver can be separate devices communicatively coupled to each other or can be integrated into one package or one device. Similarly, the processor may be integrated into one package or one device with the computer-readable non-transitory medium, which may be further integrated into one package or one device with the output driver. In an nonlimiting example the processor may be comprised in a fully integrated intelligent driver. In a nonlimiting example the output driver may comprise a smart FET. In a preferred embodiment the communication between the processor and the output driver utilizes PWM from a microcontroller output port. However, in other nonlimiting examples the communication between the processor and the output driver may also be accomplished via PWM of the SPI interface to a smart driver or modulation directly to a MOSFET.

In one embodiment the test brake controller may be separate and independent from the normal operation brake controller, wherein the communicative coupling between the test brake controller and the actuator is switched in addition to or in lieu of the communicative coupling between the normal brake controller and the actuator. Such a separate test brake controller may be offered as an aftermarket add-on to existing brake systems.

The foregoing description is for purposes of illustration only. The true scope of the invention is set forth in the following claims.

1. A brake controller apparatus for audible verification of brake circuit operation, the apparatus comprising:
a processor and an output driver, the processor communicatively coupled to the output driver, the output driver communicatively coupled to a brake actuator;
the processor configured to receive a trigger from a trigger device and configured in response to the trigger enter test mode; and
the processor further configured to send upon entering the test mode a waveform to the brake actuator, the sending utilizing the output driver, the waveform causing the brake actuator to generate a sound audible to a person performing the verification of a brake circuit, the brake circuit comprising the brake controller, the brake actuator, and a communicative coupling therebetween is operational.

2. The brake controller as claimed in claim 1 further comprising a motion detector, wherein the processor is configured to prevent entering the test mode and to terminate the test mode upon detecting substantial movement of a vehicle whose brake circuit is being verified.

3. The brake controller as claimed in claim 2 wherein the vehicle is a trailer.

4. The brake controller as claimed in claim 1 wherein the trigger device is a communication device utilizing a wireless technology to communicatively couple to the processor.

5. The brake controller as claimed in claim 4 wherein the trigger device is a fob.

6. The brake controller as claimed in claim 4 wherein the trigger device is one of a smart phone, a tablet, and a personal computer.

7. The brake controller as claimed in claim 1 wherein the waveform comprises a frequency sweep between a lower frequency limit and an upper frequency limit.

8. The brake controller as claimed in claim 1 wherein the waveform comprises a select frequency.

9. The brake controller as claimed in claim 8 wherein the select frequency is about 600 Hz.

10. The brake controller as claimed in claim 1 wherein the waveform has a duty cycle of not more than 20%.

11. The brake controller as claimed in claim 10 wherein the waveform has a duty cycle of not more than 10%.

12. A system for audible verification of brake circuit operation, the system comprising:
the brake controller apparatus as claimed in claim 1,
the triggering device,
and the brake actuator.

13. A method for audible verification of brake circuit operation, the method comprising the steps of:
receiving a trigger from a trigger device,
in response to the trigger, determining whether a vehicle is in motion,
entering the test mode if the vehicle is determined to be substantially not in motion and one of remaining in and switching to a normal mode if the vehicle is determined to not be substantially not in motion,
in the test mode:
sending a waveform to a brake actuator,
causing the brake actuator to generate a sound audible to a person performing the verification, if a brake circuit is operational.

14. The method as claimed in claim 13 wherein the waveform comprises a frequency sweep between a lower frequency limit and an upper frequency limit.

15. The method as claimed in claim 13 wherein the waveform comprises a select frequency.

16. The method as claimed in claim 15 wherein the select frequency is about 600 Hz.

17. The method as claimed in claim 13 wherein the waveform has a duty cycle of not more than 20%.

18. The method as claimed in claim 17 wherein the waveform has a duty cycle of not more than 10%.

19. The method as claimed in claim 13 further comprising the step of:
receiving waveform parameters from the trigger device.

20. The method as claimed in claim 13 wherein the triggering device is at least one of a fob, a smart phone, a tablet, and a personal computer.
